(19) United States
(12) Patent Application Publication
(10) Pub. No.: US 2009/0047905 A1
(43) Pub. Date: Feb. 19, 2009

(54) STEREO BLUETOOTH HEADSET

(75) Inventor: Bill Yang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COTRON CORPORATION, Taipei City (TW)

(21) Appl. No.: 11/938,797

(22) Filed: Nov. 13, 2007

(30) Foreign Application Priority Data
Aug. 15, 2007 (TW) 96130154

(51) Int. Cl. H04B 7/00

(52) U.S. Cl. 455/41.3

(57) ABSTRACT

A stereo bluetooth headset including a bluetooth transceiver, at least one inter-speaker, a microphone and an audio output port is provided. The bluetooth transceiver is used for transceiving signals with an electronic device in a wireless mode. The inter-speaker is electrically connected to the bluetooth transceiver for broadcasting audio signals received from the electronic device. The microphone is electrically connected to the bluetooth transceiver. The audio output port is electrically connected to the bluetooth transceiver and suitable for connecting to an audio input port of an outer-speaker through a connecting cable, so as to transmit stereo audio signals received from the electronic device to the outer-speaker through the connecting cable for broadcasting.

### CROSS-REFERENCE TO RELATED APPLICATION

This application claims the priority benefit of Taiwan application serial no. 96130154, filed on Aug. 15, 2007. All disclosure of the Taiwan application is incorporated herein by reference.

### BACKGROUND OF THE INVENTION

1. Field of the Invention

The present invention is related to a bluetooth headset, and particularly to a bluetooth headset which can output stereo audio signals to an outer-speaker.

2. Description of Related Art

With the continuous progress of technologies, electronic products are made as thin and light as possible, and thus the user can carry portable electronic products such as mini radios and walkmans anytime and anywhere. In addition, personal digital products such as MP3 players, mobile phones, Personal Digital Assistants (PDAs) or laptop (notebook) computers have become indispensable in our daily life. Moreover, the mobile phone equipped with a radio and an MP3 player has also been introduced to the market.

For the electronic products mentioned above, in order for the users to listen to the audio information in the electronic product without disturbing others, a headset has become an indispensable accessory for the electronic products. In addition, the headset provides better transmission of the sounds, such that the user can clearly listen to and understand the audio information, unlike the unclear voice transmitted through the air. Further, the audio information remains stable even when the user is in a motion state, such as exercising, driving, or in a noisy environment.

With regard to mobile phones, in order to reduce the possible harm from the EMW (Electro Magnetic Wave) to the human body, and to provide direct access to the mobile phone when the user's hands are full, a bluetooth headset has been developed in recent years. The bluetooth headset applies a so-called “bluetooth” radio specification, where signals can be transmitted directionlessly, voice and written data can both be processed, multiple devices can be connected simultaneously, signal transmission angle is not limited and signals can pass through walls. Also, a bluetooth device is power-saving and user-friendly and has become a primary choice for wireless headset of the mobile phones.

However, users usually feel uncomfortable after having worn a bluetooth headset for a long period of time when they hang the bluetooth headset on the ears to listen to the music provided by a multimedia mobile phone.

### SUMMARY OF THE INVENTION

The present invention provides users a stereo bluetooth headset as an alternative solution to continuous music listening after they feel uncomfortable from having worn an earphone for a long time.

The stereo bluetooth headset of the present invention includes a bluetooth transceiver, at least one inter-speaker, a microphone and an audio output port. The bluetooth transceiver is used for transceiving signals with an electronic device in a wireless mode. The inter-speaker is electrically connected to the bluetooth transceiver so as to broadcast audio signals received from the electronic device. The microphone is electrically connected to the bluetooth transceiver. The audio output port is electrically connected to the bluetooth transceiver and suitable for connecting to an audio input port of an outer-speaker through a connecting cable so that stereo audio signals received from the electronic device are transmitted to the outer-speaker through the connecting cable for broadcasting.

According to one embodiment of the stereo bluetooth headset in the present invention, the outer-speaker includes a household stereo speaker, a computer speaker or a television speaker.

According to one embodiment of the stereo bluetooth headset in the present invention, the stereo bluetooth headset further includes a switch. The switch is electrically connected to the bluetooth transceiver such that users can control the audio signals received from the electronic device are broadcast by the inter-speaker or the outer-speaker.

According to one embodiment of the stereo bluetooth headset in the present invention, the stereo bluetooth headset has a headphone design.

According to one embodiment of the stereo bluetooth headset in the present invention, the electronic device includes a mobile communication device, an MP3 player, a CD player, a television, a radio, a VCD player, a DVD player, a laptop (notebook) computer, a Personal Digital Assistant (PDA), a car stereo, or a household stereo.

According to one embodiment of the stereo bluetooth headset in the present invention, a plug of the connecting cable connected to the audio input port of the outer-speaker includes a USB plug, a 3.5-millimeter (mm.) plug, a 6.3-mm plug or an RCA plug.

In summary, when users feel uncomfortable after having worn earphones for a long period of time, the stereo bluetooth headset of the present invention can transmit the audio signals to the outer-speaker for broadcasting through the connecting cable.

In order to make the aforementioned and other objects, features and advantages of the present invention more comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a usage status of a stereo bluetooth headset according to one embodiment of the present invention.

### DESCRIPTION OF EMBODIMENTS

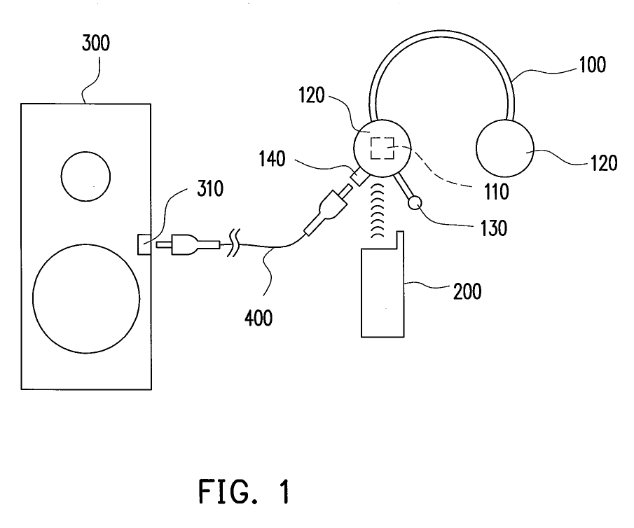

FIG. 1 is a schematic view illustrating a usage status of a stereo bluetooth headset according to one embodiment of the present invention. Referring to FIG. 1, a stereo bluetooth headset 100 of the present embodiment includes a bluetooth transceiver 110, at least one inter-speaker 120 (two inter-speakers taken as an example in the present embodiment), a microphone 130 and an audio output port 140. The bluetooth transceiver 110 is used for transceiving signals with an electronic device 200 in a wireless mode. The electronic device 200 of the present embodiment may be, for example, a multimedia mobile phone, a smart phone or any mobile communication device having a communication function and a function of bluetooth transmission of stereo audio signals. However, the electronic device 200 may also be an MP3 player, a CD player, a television, a radio, a VCD player, a DVD player, a notebook computer, a PDA, a car stereo, a household stereo or any other electronic devices having a function of bluetooth transmission of stereo audio signals.

The inter-speaker 120 is electrically connected to the bluetooth transceiver 110 so as to broadcast audio signals received from the electronic device 200. Specifically, the inter-speaker 120 may broadcast sound signals transmitted by the electronic device 200 in a wireless mode when the user is conducting sound communication. Meanwhile, the inter-speaker 120 may also broadcast stereo audio signals transmitted by the electronic device 200 in a wireless mode when the user is operating a multimedia function of the electronic device 200, such as music, radio, sound in a movie or other stereo audio signals. Additionally, a number of the inter-speakers may be only one or plural subject to different design requirements.

The microphone 130 is electrically connected to the bluetooth transceiver 110 so as to receive analog audio signals and convert them into digital audio signals and transmit the digital audio signals to the electronic device 200 through the bluetooth transceiver 110 when the user is conducting sound communication, recording or operating other functions.

The audio output port 140 is electrically connected to the bluetooth transceiver 110 and suitable for connecting to an audio input port 310 of an outer-speaker 300 through a connecting cable 400. In other words, the bluetooth transceiver 110 may transmit the stereo audio signals received from the electronic device 200 to the outer-speaker 300 for broadcasting through a path of the audio output port 140, the connecting cable 400 and the audio input port 310. Forms of the audio output port 140 and the audio input port 310 may adopt a female jack or other options. The connecting cable 400 may be a common audio signal line. The outer-speaker 300 may be a household stereo speaker, a general computer speaker, a television speaker, or any other suitable speakers. Certainly, the outer-speaker 300 may also include an amplifier (not illustrated), and the audio input port 310 is designed to be disposed on the amplifier and outputs the stereo audio signals to a horn section of the outer-speaker 300 through the amplifier. Moreover, according to different forms of the audio input port 310 of the outer-speaker 300, a plug of the connecting cable 400 connected to the audio input port 310 of the outer-speaker 300 may be a common 3.5-mm plug or a 6.3-mm plug. However, the plug may also be a USB plug, an RCA plug or any other plugs corresponding to a plug of the audio input port 310.

In the present embodiment, the stereo bluetooth headset 100 has a headphone design, but the stereo bluetooth headset 100 may also adopt a micro earphone design or any other suitable designs.

When using the stereo bluetooth headset 100 of the present embodiment to listen to the stereo audio signals provided by the electronic device 200, the stereo audio signals therefrom may be received by the bluetooth transceiver 110 and broadcast through the inter-speaker 120. When the user feels uncomfortable for having worn the stereo bluetooth headset 100 for a long period of time, the stereo audio signals from the electronic device 200 may be transmitted to the outer-speaker 300 for broadcasting through the connecting cable 400. Therefore, even if the user does not continue wearing the stereo bluetooth headset 100 and takes it off, he or she may still continue listening to the stereo audio signals, such as music, radio or sound of a movie, through the outer-speaker 300. Furthermore, since the outer-speaker 300 is less limited in its design than the inter-speaker 120, the user can enjoy better sound quality. In addition, with the stereo bluetooth headset 100, the stereo audio signals provided by any electronic device having a function of bluetooth transmission of stereo audio signals can all be transmitted to the outer-speaker 300 for broadcasting.

Moreover, the stereo bluetooth headset 100 of the present embodiment further includes a switch (not illustrated). The switch is electrically connected to the bluetooth transceiver 110. With the switch, the user can control the audio signals (including sound, music or other audio signals) received from the electronic device are broadcast by the inter-speaker 120 or the outer-speaker 300. The switch allows the user to manually switch an output path of the audio signals at any time. Alternatively, the switch may also be automatic. For example, when the bluetooth transceiver 110 receives a telephone call signal provided by the electronic device 200, the switch automatically switches sound signals to be broadcast by the inter-speaker 120 so as to allow the user proper privacy. Or the switch may be integrated on the audio output port 140. When a connection between the audio output port 140 and the connecting cable 400 is detected, the audio signals are automatically switched to be broadcast by the outer-speaker 300. Oppositely, the audio signals are automatically switched to be broadcast by the inter-speaker 120. Certainly, the switch may also adopt other suitable designs which are not to be described herein one by one.

In summary, since the stereo bluetooth headset of the present invention has an audio output port, the stereo audio signals provided by the electronic device can be transmitted to the outer-speaker through the connecting cable for broadcasting. Thus, the discomfort the user feels after having worn the earphone for a long period of time is alleviated by listening to music through the outer-speaker instead. In the meantime, if the outer-speaker has better sound quality, the user is provided with better sound quality.

Although the present invention has been disclosed above by the embodiments, they are not intended to limit the present invention. Anybody ordinarily skilled in the art can make some modifications and alterations without departing from the spirit and scope of the present invention. Therefore, the protecting range of the present invention falls in the appended claims.

What is claimed is:

1. A stereo bluetooth headset, comprising:
a bluetooth transceiver, used for transceiving signals with an electronic device in a wireless mode;
at least one inter-speaker, electrically connected to the bluetooth transceiver so as to broadcast audio signals received from the electronic device;
a microphone, electrically connected to the bluetooth transceiver; and
an audio output port, electrically connected to the bluetooth transceiver and suitable for connecting to an audio input port of an outer-speaker through a connecting cable so that stereo audio signals received from the electronic device are transmitted to the outer-speaker through the connecting cable for broadcasting.

2. The stereo bluetooth headset as claimed in claim 1, wherein the outer-speaker comprises a household stereo speaker, a computer speaker or a television speaker.

3. The stereo bluetooth headset as claimed in claim 1, further comprising a switch electrically connected to the bluetooth transceiver so that a user can control the audio signals received from the electronic device are broadcast by the inter-speaker or the outer-speaker.

4. The stereo bluetooth headset as claimed in claim 1, having a headphone design.

5. The stereo bluetooth headset as claimed in claim 1, wherein the electronic device comprises a mobile communication device, an MP3 player, a CD player, a television, a radio, a VCD player, a DVD player, a notebook computer, a personal digital assistant (PDA), a car stereo, or a household stereo.

6. The stereo bluetooth headset as claimed in claim 1, wherein a plug of the connecting cable connected to the audio input port of the outer-speaker comprises a USB plug, a 3.5-millimeter (mm.) plug, a 6.3-mm plug or an RCA plug.
